(19) United States
(12) Patent Application Publication
(10) Pub. No.: US 2017/0129516 A1
(43) Pub. Date: May 11, 2017

(54) Caster Adapter for Hand Truck

(71) Applicant: Robert R. J. Gervais, Landmark (CA)

(72) Inventor: Robert R. J. Gervais, Landmark (CA)

(21) Appl. No.: 15/340,659

(22) Filed: Nov. 1, 2016

(30) Foreign Application Priority Data
Nov. 6, 2015 (CA) 2911787

(51) Int. Cl. B62B 1/00; B62B 1/12

(52) U.S. Cl. CPC B62B 1/002; B62B 1/12; B62B 2301/04; B62B 2301/05; B62B 2301/06; B62B 2301/14

(57) ABSTRACT

A caster adapter is used for adapting a plurality of caster wheels onto a hand truck of the type having a backing frame extending longitudinally between a handle portion at a top end and a toe plate at a bottom end. The adapter includes a frame assembly mounting the caster wheel assemblies thereon for rolling movement along a ground surface. A pair of pivot couplings on the frame assembly pivotally couple the frame assembly on the backing frame of the hand truck for pivotal movement about a tilt axis which is parallel to the toe plate and proximate to the bottom end of the backing frame.

This application claims foreign priority benefits from Canadian Patent Application 2,911,787 filed Nov. 6, 2015.

### FIELD OF THE INVENTION

The present invention relates to an adapter including a caster frame assembly supporting caster wheels thereon upon which the frame of a hand truck can be pivotally supported such that the hand truck frame can be loaded and supported for rolling movement across the ground on the caster frame.

### BACKGROUND

Various forms of hand trucks are known for assisting users in supporting cargo for rolling movement across a ground surface. Hand trucks typically include a backing frame which extends longitudinally between a handle portion at a top end and a toe plate at a bottom and which protrudes forwardly and perpendicularly to the longitudinal direction of the backing frame. Two wheels are typically supported at the bottom end of the backing frame, rearwardly of the frame for rolling movement about a common lateral axis which is parallel to the toe plate. The orientation of the wheels is typically fixed such that it is difficult to displace cargo in a lateral direction once it is loaded on the hand truck.

U.S. Pat. No. 7,083,174 by Kane discloses a hand truck including an additional support protruding rearward from the backing frame with caster wheels thereon to provide additional stability to the hand truck when in a loaded and inclined position, however the primary wheels remain unsteerable such that displacement in the lateral direction remains limited.

U.S. Pat. No. 3,288,481 by Meyers discloses a hand truck including two caster wheels, however the orientation of the swivel axes of the caster wheels is fixed relative to the frame of the hand truck such that the wheels are very difficult to steer and have a preferred orientation unless the hand truck is suitably oriented with the swivel axes in a vertical direction, which is cumbersome and difficult for an operator to achieve.

U.S. Pat. No. 8,556,279 by McKinnon discloses a hand truck including omnidirectional wheels, however the construction of the wheels is complex and costly and cannot be readily applied to many existing types of hand trucks.

U.S. Pat. No. 7,464,947 by Cortese and U.S. Pat. No. 8,770,598 by Li disclose two examples of hand trucks in which the primary wheels can be pivoted into a lateral orientation for rolling movement in a lateral direction; however, the orientation of the wheels cannot be readily changed under a loaded condition such that once the hand truck is loaded, the wheels remain limited to rolling movement in either the forward direction or the lateral direction.

### SUMMARY OF THE INVENTION

According to one aspect of the invention there is provided a caster adapter for a hand truck including a backing frame extending longitudinally between opposing top and bottom ends, a handle portion at the top end, and a toe plate protruding from the backing frame at the bottom end, the adapter comprising:

a frame assembly mounting a plurality of caster wheel assemblies thereon in which each caster wheel assembly includes a frame element which is pivotal relative to the frame assembly about a swivel axis of the caster wheel assembly and a caster wheel supported on the frame element for rotation relative to the frame about a rolling axis of the caster wheel assembly such that the caster wheels are supported for rolling movement along a ground surface; and

at least one pivot coupling on the frame assembly which is arranged to couple the frame assembly to the backing frame of the hand truck for pivotal movement about a tilt axis which is parallel to the toe plate and proximate to the bottom end of the backing frame.

According to a second aspect of the present invention there is provided a hand truck comprising:

a backing frame extending longitudinally between opposing top and bottom ends;

a handle portion at the top end of the backing frame;

a toe plate protruding from the backing frame at the bottom end;

an adapter frame assembly;

a plurality of caster wheel assemblies mounted on the adapter frame assembly in which each caster wheel assembly includes a frame element which is pivotal relative to the frame assembly about a swivel axis of the caster wheel assembly and a caster wheel supported on the frame element for rotation relative to the frame about a rolling axis of the caster wheel assembly such that the caster wheels are supported for rolling movement along a ground surface; and

at least one pivot coupling which couples the frame assembly to the backing frame of the hand truck such that the backing frame is pivotal relative to the frame assembly about a tilt axis which is parallel to the toe plate and proximate to the bottom end of the backing frame.

The arrangement of a pivot coupling which connects an adapter frame assembly supporting a plurality of caster wheel assemblies thereon to a backing frame of a hand truck enables the caster wheel assemblies to remain optimally oriented for free swiveling about respective swivel axes which are perpendicular to the ground surface upon which they are supported, while still enabling the hand truck to be pivoted about the tilt axis of the pivot coupling through a range of positions including a vertically oriented at rest position with the toe plate flat on the ground through to various working positions with the backing frame at an upward incline with cargo loaded on the toe plate leaning against the backing frame. When mounting the adapter assembly in place of existing wheels of the hand truck, various commercially available hand trucks can be readily modified by replacing the two primary wheels with the caster wheels of the adapter in a manner which greatly increases the maneuverability and stability of the hand truck.

When the hand truck has at least one axle mount receiving an axle supporting primary wheels on the backing frame of the hand truck for rotation about a primary axis, preferably said at least one pivot coupling of the adapter is arranged to couple the frame assembly to the backing frame of the hand truck such that the tilt axis is coaxial with the primary axis of the hand truck by supporting the adapter frame assembly on the backing frame interchangeably with the primary wheels. More particularly, the pivot coupling may be arranged to be mounted on the existing axle of the hand truck.

Typically the swivel axes of the plurality of caster wheel assemblies are parallel to one another, perpendicularly to a common ground surface upon which the caster wheel assemblies are supported for rolling movement.

The plurality of caster wheel assemblies preferably includes at least three caster wheel assemblies.

When the frame assembly comprises two caster frames supporting respective ones of the pivot couplings thereon so as to be pivotally mounted at laterally opposing sides of the backing frame, the plurality of caster wheel assemblies preferably includes two caster wheel assemblies supported on each caster frame at opposing sides of the respective pivot coupling.

Preferably a height of said at least one pivotal coupling relative to a bottom of the caster wheel assemblies is approximately equal to a height of the primary axis relative to the toe plate of the hand truck, and is approximately equal to a radius of the primary wheels.

The pivot couplings are preferably arranged to be readily releasable from the backing frame of the hand truck, for example by allowing the pivot couplings to be removed from the axle of the hand truck using a removable cotter pin.

One embodiment of the invention will now be described in conjunction with the accompanying drawings in which:

### BRIEF DESCRIPTION OF THE DRAWINGS

FIG. 1 is a perspective view of one caster frame of the frame assembly of the adapter, shown separated from the backing frame of the hand truck;

FIG. 2 is a side elevational view one caster frame of the frame assembly of the adapter, shown separated from the backing frame of the hand truck;

FIG. 3 is a side elevational view of the hand truck mounted on the adapter with the hand truck shown in a resting position in solid line, and in a loaded working position in broken line;

FIG. 4 is a rear elevational view of the hand truck mounted on the adapter; and

FIG. 5 is a top plan view of the adapter shown separated from the hand truck.

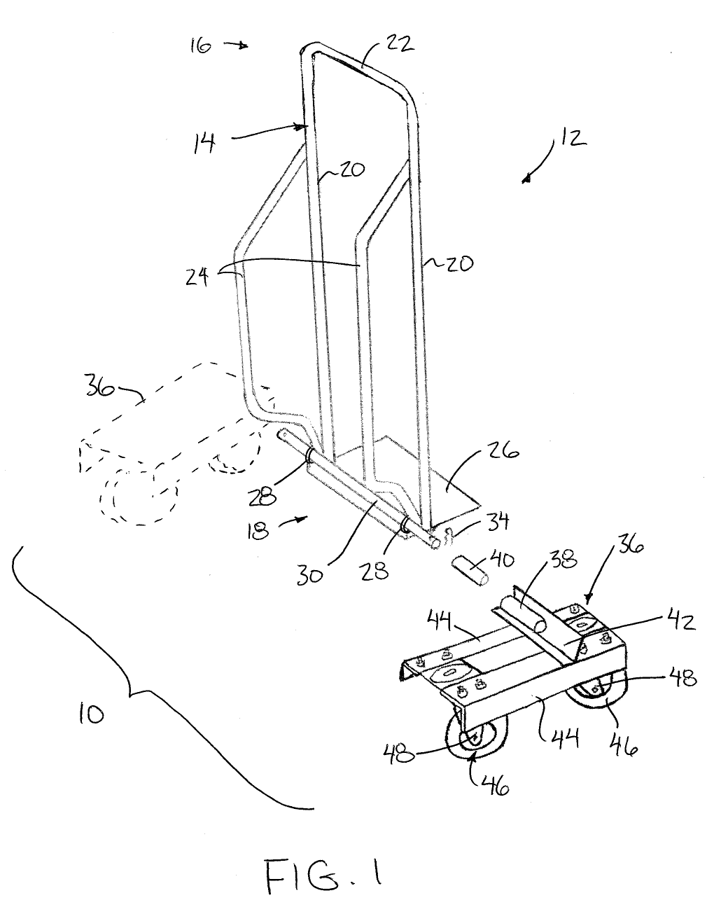

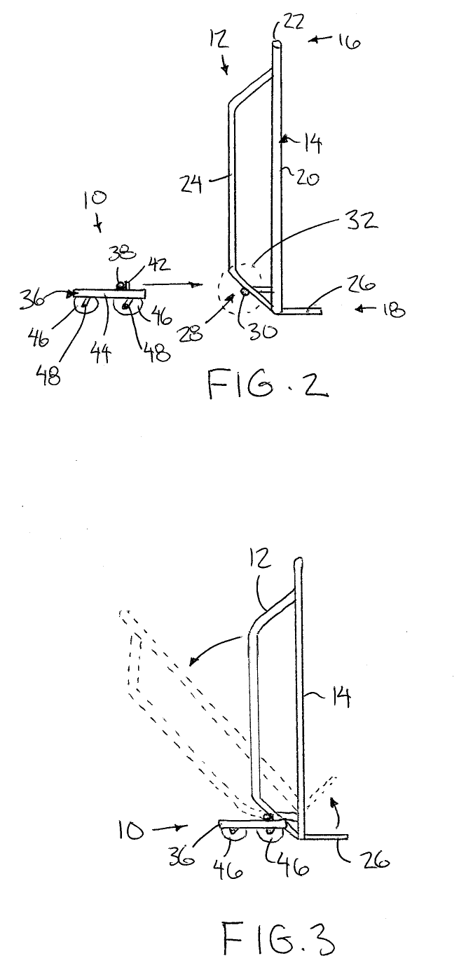

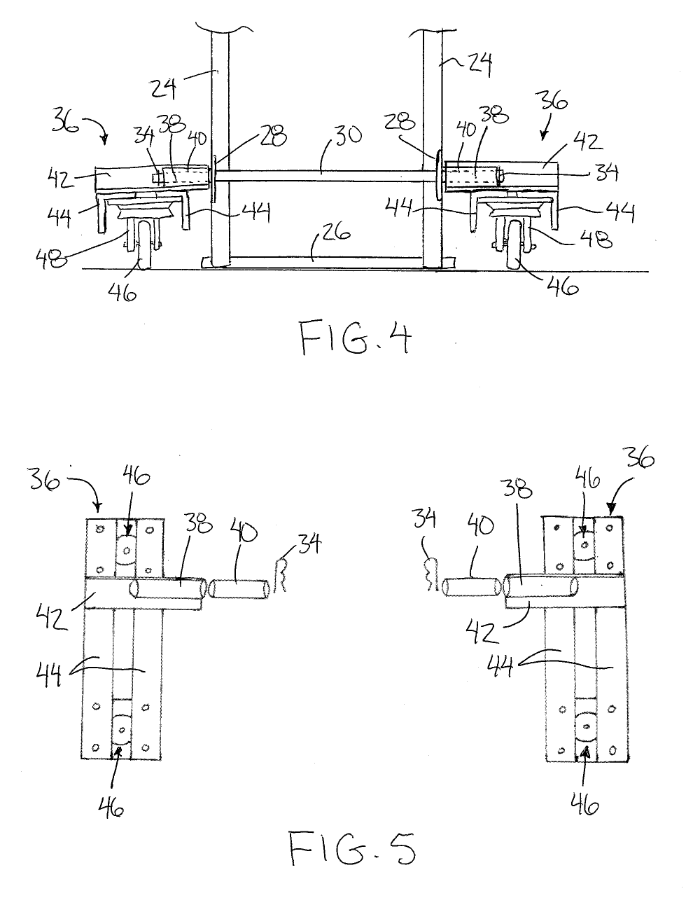

In the drawings like characters of reference indicate corresponding parts in the different figures.

### DETAILED DESCRIPTION

Referring to the accompanying figures there is illustrated a caster adapter generally indicated by reference numeral 10. The caster adapter 10 is particularly suited for use with a hand truck 12 to allow castering movement of the hand truck across a supporting surface such as a ground surface while the hand truck is positioned with cargo loaded thereon throughout a range of tilted positions relative to the supporting surface.

The hand truck 12 typically includes a backing frame 14 which is elongate in a longitudinal direction between a top end 16 and a bottom end 18 thereof. The frame 14 includes two rails 20 which extend longitudinally along opposing sides of the backing frame between the opposed top and bottom ends. A crossbar 22 is connected between the top ends of the rails to define a handle portion suitable for being grasped in the hands of an operator.

Two rear supports 24 of the backing frame are generally upright in orientation at a location which protrudes rearward from a plane of the backing frame 14 defined by the two rails 20 at laterally opposing sides of the backing frame.

A toe plate 26 is mounted at the bottom end of the two rails 20 so as to be connected therebetween and so as to protrude forwardly from the bottom end of the backing frame perpendicularly to the plane defined by the two rails 20. The toe plate generally comprises a flat rectangular plate which is suitable for supporting a load on the top side thereof such that the load can be leaned against the front side of the rails of the backing frame 14 when the hand truck is tilted so that the backing frame extends upward at a rearward inclination in a loaded and working position.

The backing frame 14 typically includes two axle mounts 28 supported on the two rear supports 24 proximate the bottom end thereof at laterally opposing sides of the backing frame. The two axle mounts typically comprise a collar, bushing, or annular bearing for example for mounting a primary wheel axle 30 extending laterally through both axle mounts so as to be parallel to the toe plate at a location spaced upwardly therefrom and spaced rearwardly from the plane of the two rails 20 of the backing frame opposite the toe plate. In normal use, a primary wheel (shown in broken line) 32 is mounted at each end of the axle at laterally opposing sides of the backing frame. A transverse aperture at each end of the wheel axle 30 receives a cotter pin 34 to selectively retain the primary wheels 32 mounted at opposing ends of the axle such that the wheels are readily removable by removing the cotter pin. The radius of the primary wheels is approximately equal to the height of the two axle mounts 28 from the toe plate in a normal at rest position of the hand truck with the toe plate lying flat against the supporting surface. Once cargo was loaded onto the top side of the toe plate, the hand truck is intended to be tilted rearwardly so as to be carried on the primary wheels for rolling movement along the ground surface in a tilted and loaded working position of the hand truck.

The adapter 10 is intended to be mounted interchangeably with the primary wheels 32 such that the primary wheels are removed from the hand truck prior to attachment of the adapter. The adapter includes a frame assembly comprised of two individual caster frames 36 which are mounted at laterally opposing sides of the backing frame of the hand truck in place of the two primary wheels 32 respectively.

Each caster frame 36 includes a pivot coupling 38 in the form of a laterally oriented tube receiving a bushing sleeve 40 therein which in turn receives the respective end of the axle 30 of the hand truck therein. The tube defining the pivot coupling has a length in the lateral direction of the primary wheel axis between inner and outer ends thereof which corresponds approximately to the axial length of the hub of a typical primary wheel replaced by the adapter. Accordingly the opposing ends of the wheel axle 30 are arranged to extend through the pivot couplings sufficiently that the apertures at opposing ends of the axle are exposed to receive the cotter pin 34 therein to selectively retain the pivot couplings mounted at opposing ends of the axle of the hand truck. In this manner the caster frames remain readily releasable from the hand truck by removing the cotter pin to replace the adapter with the primary wheels again as may be desired.

Each caster frame includes a crossbar 42 in the form of an angle iron forming a rigid frame member which is fixed to the tube of the pivot coupling to extend in the lateral direction alongside the tube while protruding laterally outward beyond the outer end of the tube. Two beam elements 44 of the caster frame are mounted parallel to one another and spaced apart in the lateral direction to be fixed to the crossbar perpendicularly thereto and perpendicularly to the lateral axis of the pivot coupling. The two beam elements 44 are formed of rigid angle iron to define the majority of the structure of each caster frame. The two beam elements 44 define a plane of the caster frame which is typically horizontally oriented under normal use so as to be parallel to the ground surface upon which the caster frames are supported for rolling movement.

Each caster frame 36 mounts two caster wheel assemblies 46 thereon at longitudinally opposed ends of the beam elements 44 at diametrically opposing sides of the pivot coupling such that each pivot coupling is located at an intermediate position along the beam elements between the two respective caster wheel assemblies. Accordingly a front portion of each caster frame protrudes forwardly from the pivot coupling 38 towards a front end supporting one of the caster wheel assemblies 46 thereon and a rear portion of each caster frame protrudes rearwardly from the pivot coupling towards a rear end supporting the other one of the caster wheel assemblies 46 thereon. The rear portion is longer than the front portion of each caster frame such that the front portion does not protrude beyond the plane of the backing frame in a mounted position so as not to interfere with loading of cargo onto the front side of the hand truck.

Each caster wheel assembly 46 includes a frame element 48 which is pivotally coupled to a bottom side of the beam elements 44 such that the frame element is pivotal about a respective swivel axis which is perpendicular to a plane of the caster frame defined by the beam elements 44 so as to also be perpendicular to a ground surface upon which the caster wheel assemblies are supported for rolling movement. Each caster wheel assembly 46 further includes a caster wheel 50 rotatably supported on the frame element 48 for rolling movement about a respective rolling axis which is perpendicular to the swivel axis so as to be horizontally oriented parallel to the ground surface in use. Orientation of the rolling axis about the swivel axis varies as the frame element is pivoted relative to the caster frame.

The two caster wheel assemblies on each caster frame are arranged for independent rolling and swiveling movement about the respective axes thereof however the swivel axes are parallel to one another such that the caster wheels typically follow the same direction of rolling movement as the operator directs the movement of the overall hand truck.

The two caster frames are pivotally coupled at opposing sides of the hand truck frame so as to be independently pivotal relative to one another about the common tilt axis defined by the pivot couplings connected to the axle of the hand truck at the primary axis of the wheels. On a typical level supporting surface, all of the swivel axes of the four caster wheels will accordingly be parallel to one another.

The height of the pivot couplings 38 relative to the caster wheels supported on a ground surface is approximately equal to the radius of the primary wheels, which is in turn approximately equal to the height of the wheel axle of the hand truck relative to the toe plate when the toe plate is engaged flat on the ground. Accordingly the adapter similarly allows the hand truck to be supported at rest with the toe plate laying flat against the ground surface.

Use of the adapter involves removing the primary wheels of the hand truck if present by removing the cotter pin 34 at each end of the axle. The two caster frames are independently mounted at opposing ends of the existing axle of the hand truck and retained in place using the cotter pins. With the hand truck initially positioned at rest with the toe plate flat against the ground surface upon which the caster wheels are supported for rolling movement, cargo can be initially loaded onto the hand truck in the usual manner by supporting the cargo on the top side of the toe plate with the cargo leaning against the front side of the backing frame. The backing frame can be tilted rearward by pivoting the hand truck about the tilt axis defined by the pivot couplings 38 such that the toe plate is displaced upwardly and rearwardly from the at rest position while the handle portion at the top end of the backing frame is displaced generally rearwardly towards the working position. In the working position, cargo is loaded on the hand truck, the backing frame extends at an upward and rearward incline from the toe plate, and the backing frame and toe plate are supported entirely on the caster frames which are in turn supported by the caster wheels for rolling movement along the ground surface. The upward and rearward incline of the backing frame in the working position can be oriented through a range of angles relative to the ground while the caster frames remain parallel to the ground such that the swivel axes of all caster wheels remain generally perpendicular to the ground. This allows the operator to readily position the centre of gravity of the load over top of the caster frames while the caster wheels remain readily steerable about their respective swivel axes for movement of the hand truck in any direction with ease.

In further embodiments the caster assembly may comprise a single caster frame supporting three or more caster wheels thereon with a pivot coupling which can be configured for mounting the backing frame of the hand truck thereon for pivoting movement about a tilt axis other than the primary axis of the existing primary wheels of the hand truck. In yet further embodiments a dedicated hand truck may be provided with one or more caster frames permanently pivotally coupled thereto which is in turn supported by caster wheels for rolling movement along the ground.

Since various modifications can be made in my invention as herein above described, it is intended that all matter contained in the accompanying specification shall be interpreted as illustrative only and not in a limiting sense.

1. A caster adapter for a hand truck including a backing frame extending longitudinally between opposing top and bottom ends, a handle portion at the top end, and a toe plate protruding from the backing frame at the bottom end, the adapter comprising:
a frame assembly mounting a plurality of caster wheel assemblies thereon in which each caster wheel assembly includes a frame element which is pivotal relative to the frame assembly about a swivel axis of the caster wheel assembly and a caster wheel supported on the frame element for rotation relative to the frame about a rolling axis of the caster wheel assembly such that the caster wheels are supported for rolling movement along a ground surface; and
at least one pivot coupling on the frame assembly which is arranged to couple the frame assembly to the backing frame of the hand truck for pivotal movement about a tilt axis which is parallel to the toe plate and proximate to the bottom end of the backing frame.

2. The adapter according to claim 1 for a hand truck having at least one axle mount for receiving an axle supporting primary wheels on the backing frame of the hand truck for rotation about a primary axis, wherein said at least one pivot coupling of the adapter is arranged to couple the frame assembly to the backing frame of the hand truck such that the tilt axis is coaxial with the primary axis of the hand truck.

3. The adapter according to claim 2 wherein said at least one pivot coupling is arranged to be supported on the backing frame of the hand truck interchangeably with the primary wheels of the hand truck.

4. The adapter according to claim 2 wherein said at least one pivot coupling is arranged to be mounted on the axle on said at least one axle mount of the hand truck.

5. The adapter according to claim 1 wherein the swivel axes of the plurality of caster wheel assemblies are parallel to one another.

6. The adapter according to claim 1 wherein the plurality of caster wheel assemblies includes at least three caster wheel assemblies.

7. The adapter according to claim 1 wherein the plurality of caster wheel assemblies includes four caster wheel assemblies.

8. The adapter according to claim 1 wherein the frame assembly comprises two caster frames supporting respective ones of the pivot couplings thereon so as to be arranged to be pivotally mounted at laterally opposing sides of the backing frame of the hand truck.

9. The adapter assembly according to claim 8 wherein the plurality of caster wheel assemblies includes two caster wheel assemblies supported on each caster frame at opposing sides of the respective pivot coupling.

10. The adapter according to claim 1 for a hand truck having at least one axle mount for receiving an axle supporting primary wheels on the backing frame of the hand truck for rotation about a primary axis, wherein a height of said at least one pivotal coupling relative to a bottom of the caster wheel assemblies corresponds approximately to a height of the primary axis relative to the toe plate of the hand truck.

11. The adapter according to claim 1 for a hand truck having at least one axle mount for receiving an axle supporting primary wheels on the backing frame of the hand truck for rotation about a primary axis, wherein a height of said at least one pivotal coupling relative to a bottom of the caster wheel assemblies corresponds approximately to a radius of the primary wheels.

12. The adapter according to claim 1 wherein said at least one pivot coupling is arranged to be readily releasable from the backing frame of the hand truck.

13. The hand truck according to claim 1 wherein the frame assembly comprises two caster frames supporting respective ones of the pivot couplings thereon so as to be pivotally mounted at laterally opposing sides of the backing frame.

14. The hand truck according to claim 13 wherein the plurality of caster wheel assemblies includes two caster wheel assemblies supported on each caster frame at opposing sides of the respective pivot coupling.

15. A hand truck comprising:
a backing frame extending longitudinally between opposing top and bottom ends;
a handle portion at the top end of the backing frame;
a toe plate protruding from the backing frame at the bottom end;
an adapter frame assembly;
a plurality of caster wheel assemblies mounted on the adapter frame assembly in which each caster wheel assembly includes a frame element which is pivotal relative to the frame assembly about a swivel axis of the caster wheel assembly and a caster wheel supported on the frame element for rotation relative to the frame about a rolling axis of the caster wheel assembly such that the caster wheels are supported for rolling movement along a ground surface; and
at least one pivot coupling which couples the frame assembly to the backing frame of the hand truck such that the backing frame is pivotal relative to the frame assembly about a tilt axis which is parallel to the toe plate and proximate to the bottom end of the backing frame.

16. The hand truck according to claim 15 further comprising at least one axle mount receiving an axle supporting primary wheels on the backing frame of the hand truck for rotation about a primary axis, wherein said at least one pivot coupling of the adapter is arranged to couple the frame assembly to the backing frame of the hand truck such that the tilt axis is coaxial with the primary axis of the hand truck.

17. The hand truck according to claim 16 wherein said at least one pivot coupling is arranged to be supported on the backing frame interchangeably with the primary wheels.

18. The hand truck according to claim 17 wherein said at least one pivot coupling is arranged to be mounted on the axle.

19. The hand truck according to claim 15 wherein the swivel axes of the plurality of caster wheel assemblies are parallel to one another.

20. The hand truck according to claim 15 wherein the plurality of caster wheel assemblies includes at least three caster wheel assemblies.
